(19) United States
(12) Patent Application Publication
(10) Pub. No.: US 2014/0295226 A1
(43) Pub. Date: Oct. 2, 2014

(54) CELL ASSEMBLY TYPE BATTERY COOLING APPARATUS

(71) Applicant: SK INNOVATION CO., LTD., Seoul (KR)

(72) Inventors: Ji Seok Lee, Yeongi-gun (KR); Sang Hyuk Kim, Daejeon (KR); Hyo Jin Hong, Daejeon (KR)

(73) Assignee: SK INNOVATION CO., LTD., Jongno-gu, Seoul (KR)

(21) Appl. No.: 14/363,037

(22) PCT Filed: Nov. 29, 2012
(86) PCT No.: PCT/KR2012/010237

§ 371 Date: Jun. 5, 2014

(30) Foreign Application Priority Data
Dec. 8, 2011 (KR) 10-2011-0131144

(51) Int. Cl. H01M 10/6563

(52) U.S. Cl. CPC H01M 10/5067
USPC 429/71; 429/83

(57) ABSTRACT

Provided is a cooling apparatus for a cell assembly type battery configured of a plurality of battery cells. The cooling apparatus is to discharge air introduced into an air inlet to an air outlet via a cooling channel between battery cells to cool a cell assembly type battery, in which a cooling channel covering plate covering a portion of the cooling channel is disposed before or behind the cooling channel so that the cooling channel having the flow of cooling air relatively faster than that in any other cooling channel has an introduction amount of air relatively smaller than that into other cooling channels. Therefore, the cooling efficiency may be excellent and each battery cell may be uniformly cooled without large deviation.

### TECHNICAL FIELD

The present invention relates to a cooling apparatus for a cell assembly type battery in which a plurality of battery cells are assembled.

### BACKGROUND ART

Unlike a primary battery, a secondary battery may be generally charged and discharged and has been used in advanced electric and electronic fields such as a hybrid vehicle, a notebook, and a computer.

As the secondary battery, there is a cell assembly type in which a plurality of battery cells are assembled. This cell assembly type has a high output characteristic.

The cell assembly type battery has a characteristic in that cooling has a larger effect on battery efficiency.

Therefore, Korean Patent Laid-Open Publication No. 2011-0044387 and Korean Patent Laid-Open Publication No. 2010-0012018 disclose a technology for improving cooling efficiency of a battery.

Describing in detail, each battery cell is disposed at an interval to form a space (generally, referred to as ‘cooling channel’) between the battery cells, in which the plurality of battery cells are disposed in a case.

Further, the case is provided with an air inlet through which cooling air is introduced and an air outlet and is provided with a fan for making the cooling air forcibly flow.

However, by making the cooling air pass through the air inlet and the air outlet, the improvement in cooling efficiency may be limited and a uniform cooling effect may not be obtained.

To improve the cooling efficiency and obtain the uniform cooling effect, according to the related art, the air introduced into the air inlet is distributed to an air distribution space of an air introduction duct or an air discharge duct which is disposed in front of the battery cell to flow in each cooling channel.

Further, the air distribution space has an inclined shape so that a cross sectional area is narrow toward the fan and the cross sectional area is wide away from the fan.

However, even by the above structure, the uniform cooling effect of the battery cell may be limited and therefore the effect may not come up to expectations.

In particular, when the cooling channel is narrow or when a total length of a section in which the battery cell is mounted is short, the improvement in cooling efficiency and the uniform cooling may not be made.

### DISCLOSURE

### Technical Problem

An object of the present invention is to provide a cooling apparatus for a cell assembly type battery capable of making cooling efficiency excellent and uniformly cooling each battery cell without large deviation of cooling.

### Technical Solution

In one general aspect, a cooling channel covering plate covering a portion of the cooling channel is disposed before or behind the cooling channel so that the cooling channel having the flow of cooling air relatively faster than that in any other portion has an introduction amount of air relatively smaller than that into other cooling channels.

Further, an air introduction duct or an air discharge duct is provided with an air distribution space connected to a plurality of cooling channels to be filled with introduced cooling air, wherein the air distribution space disposed before or behind the cooling channel in which the flow of air is fast corresponds to only a portion of a section from an upper portion to a lower portion of a battery cell so that the cooling channel having the flow of air relatively faster than that in any other portion has an introduction amount of air relatively smaller than that into other cooling channels and a length of the corresponding section is smaller than a portion corresponding to the cooling channel having the relatively slower flowing speed of air.

Therefore, the cooling apparatus for a cell assembly type battery may make cooling efficiency excellent and uniformly cool each battery cell without large deviation of cooling.

### Advantageous Effects

According to the cooling apparatus for a battery in accordance with the exemplary embodiments of the present invention, the cooling channel covering plate which covers a portion of the cooling channel is disposed before or behind the cooling channel so that the cooling channel having the flow of introduced cooling air relatively faster than that in any other portion due to the distance from the fan, the interval size of the cooling channel, or the like has the introduction amount of air relatively smaller than that into other cooling channels.

Therefore, the cooling efficiency may be excellent and each battery cell may be uniformly cooled without large deviation.

Further, when the air introduction duct or the air discharge duct is provided with the air distribution space connected to the plurality of cooling channels to be filled with the introduced cooling air, the air distribution space disposed before or behind the cooling channel in which the flow of air may be fast corresponds to only a portion of the section from the upper portion to the lower portion of the battery cell so that the cooling channel which may have the flow of air relatively faster than that in any other portion has the introduction amount of air relatively smaller than that into other cooling channels, in which the length of the corresponding section is smaller than a portion corresponding to the cooling channel having the relatively slower flowing speed of air.

Therefore, the cooling efficiency may be excellent and each battery cell may be uniformly cooled without large deviation.

### DESCRIPTION OF DRAWINGS

The above and other objects, features and advantages of the present invention will become apparent from the following description of preferred embodiments given in conjunction with the accompanying drawings, in which:

FIG. 1 is a schematic diagram illustrating a cooling apparatus for a battery having a cooling channel covering plate according to an exemplary embodiment of the present invention, in which (A) illustrates a form in which the cooling channel covering plate stops an upper portion of the cooling channel, and (B) illustrates a form in which the cooling channel covering plate stops a lower portion of the cooling channel.

FIG. 2 is a schematic diagram for describing a case in which the exemplary embodiment of the present invention is applied to a structure having an air introduction duct and an air discharge duct; and

FIG. 3 is a diagram illustrating an image through which a temperature distribution of a battery cell in the structure of FIG. 2 may be understood.

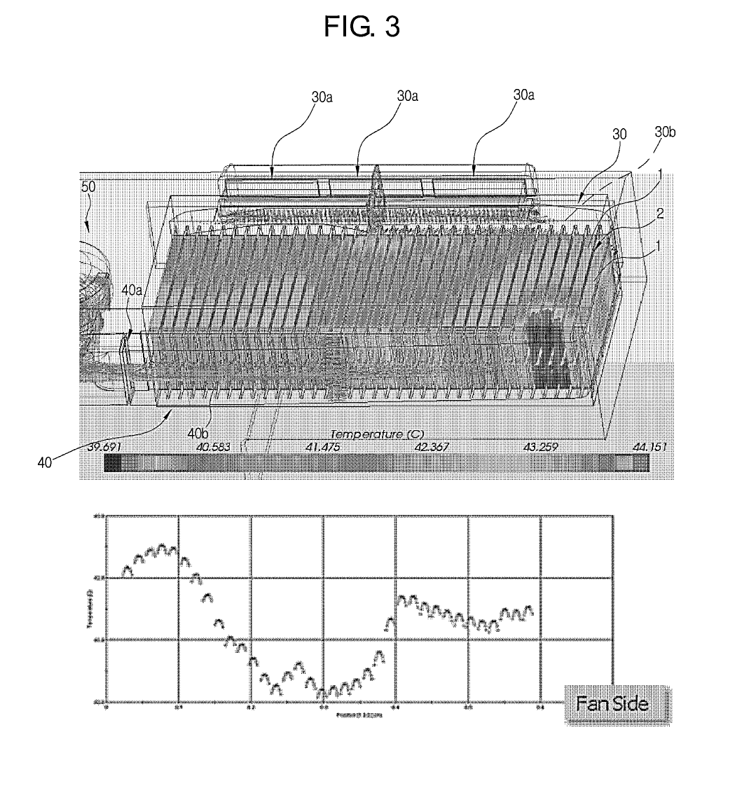

### BEST MODE

Hereinafter, a technical spirit of the present invention will be described in more detail with reference to the accompanying drawings.

However, the accompanying drawings are only examples shown in order to describe the technical idea of the present invention in more detail. Therefore, the technical idea of the present invention is not limited to shapes of the accompanying drawings.

An exemplary embodiment of the present invention relates to a cooling apparatus for a battery to cool a cell assembly type battery.

Therefore, like the related art, in order for the cooling apparatus according to the exemplary embodiment of the present invention to cool the cell assembly type battery, air introduced into an air inlet 30a is discharged to an air outlet 40a via a cooling channel 2 between battery cells 1.

However, an object of the present invention is to provide a cooling apparatus for a cell assembly type battery which may have excellent cooling efficiency and uniformly cool each battery cell 1 without large deviation.

It may be appreciated that the reason why it is difficult to improve cooling efficiency and uniform cool the battery cell 1 only by a technology of inclining an air introduction duct and an air discharge duct in which an air distribution space is formed is that it does not appropriately cope with a flowing speed of air passing through each cooling channel 2.

That is, as the cooling channel 2 is closed to the air outlet or a fan, the flowing speed of air is fast, while as the cooling channel 2 is away from the air outlet or the fan, the flowing speed of air is slow.

Further, the cooling channel 2 having a wide width has the flowing speed of air faster than that of the cooling channel 2 having a narrow width but a method of making the width of the cooling channel 2 different is not commercialized due to economical efficiency, performance of a battery, and the like.

Therefore, like the related art, only tilting the air introduction duct or the air discharge duct has a difficulty in controlling the flowing speed of air of the cooling channel 2 and uniformly cooling the battery cell 1 by controlling the flowing speed of air.

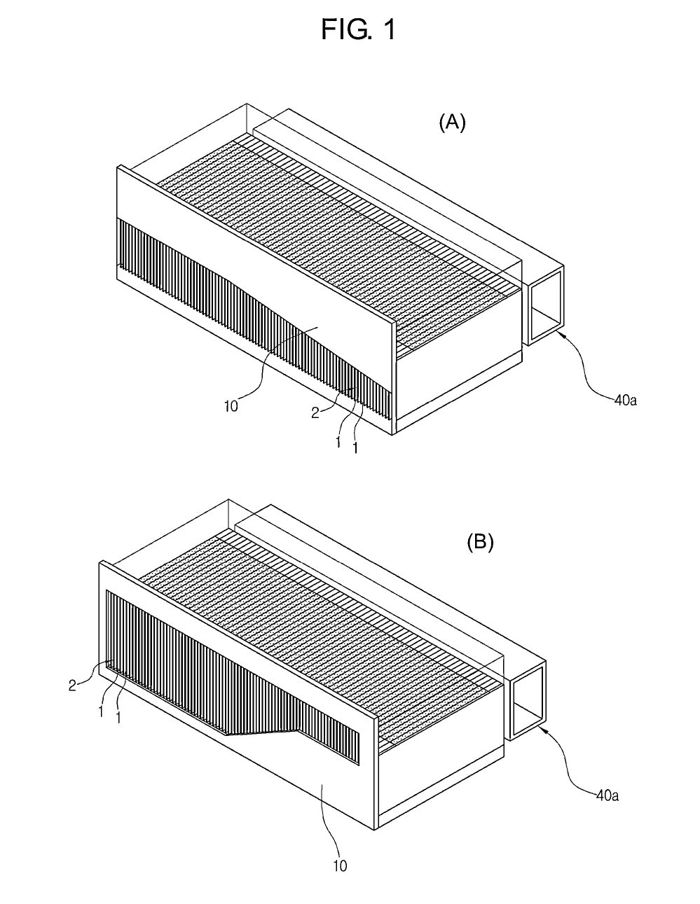

As a structure to solve the above problem, according to the exemplary embodiment of the present invention, there is a structure in which a cooling channel covering plate 10 covering a portion of the cooling channel 2 is disposed before or behind the cooling channel 2 so that the cooling channel having the flow of cooling air relatively faster than that in any other cooling channel (it occurs due to the reason that the cooling channel is closer to the fan than other cooling channels, and the like) has the introduction amount of air relatively smaller than that into other cooling channels (it occurs due to the reason that the cooling channel is away from the fan) (see FIG. 1).

That is, an area of an air introduction part or an air discharge part of the cooling channel 2 is wide or narrow by the cooling channel covering plate 10 to control the introduction amount of air into the cooling channel 2.

As in the related art, a technical concept as described above may be applied to the structure having the air introduction duct or the air discharge duct.

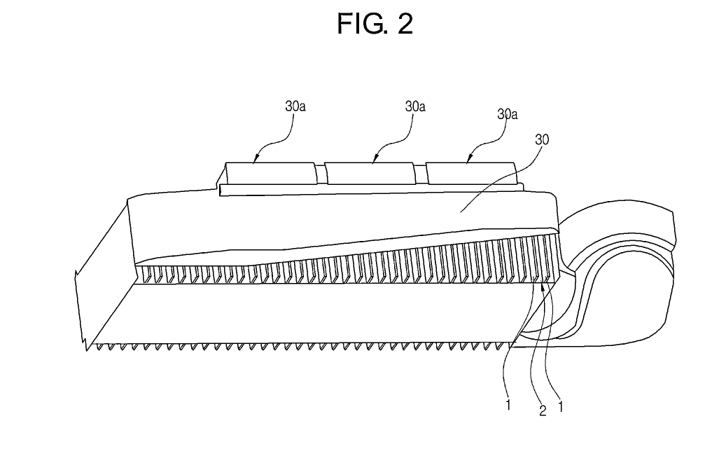

In this case, as illustrated in FIG. 2, an air introduction duct 30 or an air discharge duct 40 are provided with air distribution spaces 30b and 40b connected to the plurality of cooling channels 2 to be filled with the introduced cooling air.

In this structure, the cooling channel 2 which may have the flow of air relatively faster than in any other portion is configured so that the introduction amount of air relatively smaller than that into other cooling channels 2.

That is, the air distribution space 30b disposed before or behind the cooling channel 2 in which the flow of air may be fast corresponds to only a portion of the section from the upper portion to the lower portion of the battery cell 1, in which the length of the corresponding section is implemented to be smaller than a portion corresponding to the cooling channel having the relatively slower flowing speed of air.

The structure also has a form to control the amount of air introduced into the cooling channel 2.

According to the exemplary embodiment of the present invention, the structure may be provided with the fan to forcibly discharge the cooling air forcibly introduced into the air inlet 30a to the air outlet 40a.

Further, it is preferable that as the cooling channel covering plate 10 is closed to the fan, the area covering the cooling channel 2 is wide and as the cooling channel covering plate 10 is away from the fan, the cooling channel covering plate 10 has a portion P1 at which the area covering the cooling channel 2 is small.

Further, according to the structure having the air distribution spaces 30b and 40b, it is preferable that in the section from the upper portion to the lower portion of the battery cell 1, the length of the section to which the air distribution spaces 30b and 40b correspond is short as the cooling channel covering plate is closed to the fan and the air distribution spaces 30b and 40b have a long portion P2 as the cooling channel covering plate is away from the fan.

1. A cooling apparatus for a cell assembly type battery to discharge air introduced into an air inlet to an air outlet via a cooling channel between battery cells to cool a cell assembly type battery, wherein
a cooling channel covering plate covering a portion of the cooling channel is disposed before or behind the cooling channel so that the cooling channel having the flow of cooling air relatively faster than that in any other cooling channel has an introduction amount of air relatively smaller than that into other cooling channels.

2. A cooling apparatus for a cell assembly type battery to discharge air introduced into an air inlet to an air outlet via a cooling channel between battery cells to cool a cell assembly type battery, the cooling apparatus comprising:
an air introduction duct or an air discharge duct which is provided with an air distribution space connected to a plurality of cooling channels to be filled with introduced cooling air,
wherein the air distribution space disposed before or behind the cooling channel in which the flow of air is fast corresponds to only a portion of a section from an upper portion to a lower portion of a battery cell so that the cooling channel having the flow of air relatively faster than that in any other cooling channel has an introduction amount of air relatively smaller than that into other cooling channels and a length of the corresponding section is smaller than a portion corresponding to the cooling channel having the relatively slower flowing speed of air.

3. The cooling apparatus of claim 1, further comprising:
a fan to forcibly discharge the cooling air forcibly introduced into an air inlet to an air outlet,
wherein as the cooling channel covering plate is closed to the fan, the area covering the cooling channel is wide and as the cooling channel covering plate is away from the fan, the t cooling channel covering plate has a portion at which the area covering he cooling channel is small.

4. The cooling apparatus of claim 2, further comprising:
a fan to forcibly discharge the cooling air forcibly introduced into an air inlet to an air outlet,
wherein in the section from the upper portion to the lower portion of the battery cell, the length of the section to which the air distribution spaces correspond is short as the cooling channel covering plate is closed to the fan and the air distribution spaces have a long portion as the cooling channel covering plate is away from the fan.
